(19) United States
(12) Patent Application Publication
(10) Pub. No.: US 2026/0074320 A1
(43) Pub. Date: Mar. 12, 2026

(54) BATTERY MODULE AND VEHICLE

(71) Applicant: EVE ENERGY CO., LTD., Huizhou (CN)

(72) Inventor: Yuqi HE, Huizhou (CN)

(73) Assignee: EVE ENERGY CO., LTD., Huizhou (CN)

(21) Appl. No.: 19/326,762

(22) Filed: Sep. 12, 2025

(30) Foreign Application Priority Data
Sep. 12, 2024 (CN) 202422242570.3

(51) Int. Cl. H01M 10/6568; H01M 10/613; H01M 10/625; H01M 10/647; H01M 10/6554

(52) U.S. Cl. CPC H01M 10/6568; H01M 10/613; H01M 10/625; H01M 10/647; H01M 10/6554; H01M 2220/20

(57) ABSTRACT

The present application provides a battery module and a vehicle. The battery module includes: a battery body, a liquid cooling plate, and connecting tubes. The battery body and the liquid cooling plate are stacked, and the liquid cooling plate includes fluid inlet and outlet ports. Each connecting tube corresponds to a respective one of the fluid inlet and outlet ports, and each connecting tube includes: a connecting tube body, a connecting elbow, and a first connecting flange. In each connecting tube, a first end of the connecting tube body is fixedly connected to the liquid cooling plate at a corresponding one of the fluid inlet and outlet ports, a second end of the connecting tube body is connected to one end of the connecting elbow, and an end of the connecting elbow facing away from the connecting tube body is directly fixed to the first connecting flange.

### CROSS-REFERENCE TO RELATED APPLICATION

This disclosure claims priority to Chinese Patent Application No. 2024222425703, filed on Sep. 12, 2024, the entire contents of which are incorporated herein by reference.

### TECHNICAL FIELD

The present disclosure relates to the technical field of batteries, and particularly to a battery module and a vehicle.

### BACKGROUND

As the main energy storage component in electric vehicles, the battery is a key part that directly affects the performance of the electric vehicle.

Generally, during operation, the battery generates a certain amount of heat, which leads to an increase in the internal temperature of the battery. If heat dissipation is not timely, the accumulation of heat inside the battery may cause phenomena such as electrolyte leakage, gas emission, and smoke generation, and in severe cases, may even cause the battery to undergo intense combustion or explosion. The related art uses a liquid cooling plate to cool the battery. In particular, an interface of the liquid cooling plate is connected to an interface of the vehicle liquid cooling system via connecting pipelines and quick connectors, so that the coolant exchanges heat inside the liquid cooling plate, thereby reducing the temperature of the battery.

However, the distance between the interface of the liquid cooling plate and the interface of the vehicle liquid cooling system is usually constant, while the height of the quick connector is generally large, which leads to an increased distance between the pipeline and the liquid cooling plate, thus resulting in an increase of the volume of the battery package.

### SUMMARY

In a first aspect, the present disclosure provides a battery module, including: a battery body, a liquid cooling plate, and a plurality of connecting tubes; the battery body and the liquid cooling plate are arranged in a stacked manner, and the liquid cooling plate includes a plurality of fluid inlet and outlet ports; each of the plurality of connecting tubes corresponds to a respective one of the plurality of fluid inlet and outlet ports, and each connecting tube comprises: a connecting tube body, a connecting elbow, and a first connecting flange; where, in each of the plurality of connecting tubes, a first end of the connecting tube body is fixedly connected to the liquid cooling plate at a corresponding one of the plurality of fluid inlet and outlet ports, a second end of the connecting tube body is connected to one end of the connecting elbow, and an end of the connecting elbow facing away from the connecting tube body is directly fixed to the first connecting flange.

In a second aspect, the present disclosure provides a vehicle, including: a vehicle body, and a battery module and a liquid cooling system installed in the vehicle body, where the liquid cooling plate in the battery module is connected to the liquid cooling system via connecting tubes, and the battery module is any one of the battery modules described above.

The beneficial effects of the present disclosure are as follows. Since the end of the connecting elbow facing away from the connecting tube body is directly fixed to the first connecting flange, it is possible to eliminate a vertical short tube provided on the first connecting flange, thus eliminating the need for a quick connector. This can significantly reduce the space occupied by the entire connecting tube in the direction perpendicular to the liquid cooling plate, and can reduce the distance between the connecting tube and the liquid cooling plate, thereby effectively reducing the volume of the battery package.

### BRIEF DESCRIPTION OF THE DRAWINGS

FIG. 1 is a schematic structural diagram of a battery module provided in an embodiment of the present disclosure;

FIG. 2 is a schematic structural diagram of a liquid cooling plate provided in an embodiment of the present disclosure;

FIG. 3 is a schematic structural diagram of a connecting elbow and a first connecting flange provided in an embodiment of the present disclosure;

FIG. 4 is an exploded view of the connecting elbow and the first connecting flange shown in FIG. 3;

FIG. 5 is a schematic structural diagram of a connecting tube provided in an embodiment of the present disclosure;

FIG. 6 is a schematic structural diagram of a connecting tube, a second connecting flange, and a cooling tube provided in an embodiment of the present disclosure;

FIG. 7 is another schematic structural diagram of a battery module provided in an embodiment of the present disclosure; and

FIG. 8 is a partial exploded view shown in FIG. 1.

Reference numerals in the drawings:
000, battery module; 100, battery body; 200, liquid cooling plate; 300, connecting tube; K, fluid inlet and outlet port; 301, connecting tube body; 302, connecting elbow; 303, first connecting flange; K1, fluid inlet; K2, fluid outlet; 3021, elbow body; 3022, annular boss; 3023, snap-fit tube; 30231, snap-fit portion; 304, second connecting flange; 305, cooling tube; M1, first opening.

### DETAILED DESCRIPTION

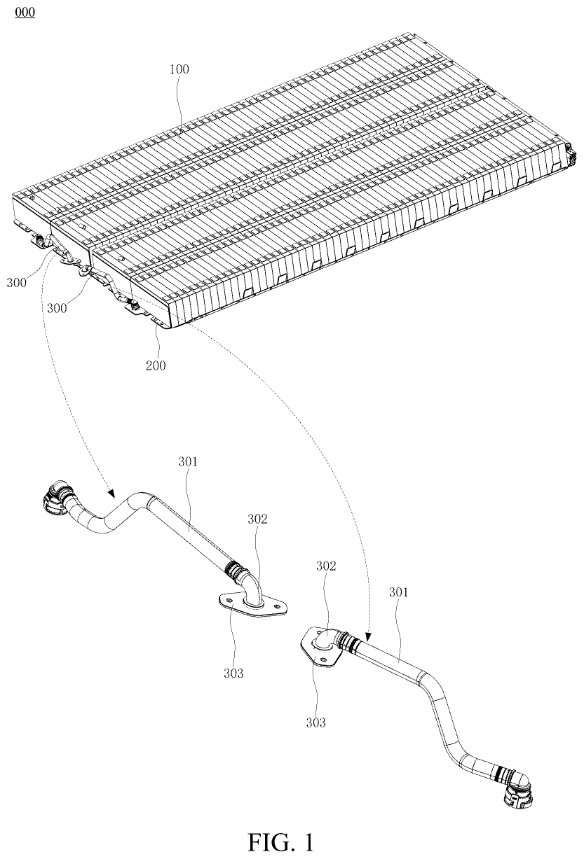

Referring to FIG. 1, which is a schematic structural diagram of a battery module provided in an embodiment of the present disclosure. The battery module 000 may include: a battery body 100, a liquid cooling plate 200, and a plurality of connecting tubes 300.

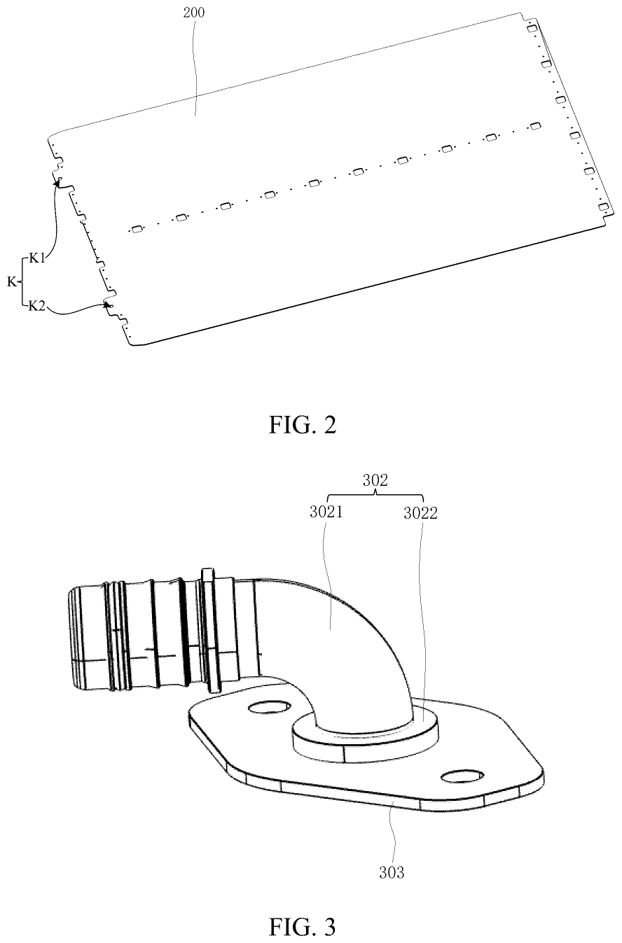

Referring to FIG. 2, which is a schematic structural diagram of a liquid cooling plate provided in an embodiment of the present disclosure. The battery body 100 and the liquid cooling plate 200 in the battery module 000 are arranged in a stacked manner, and the liquid cooling plate 200 in the battery module 000 may have a plurality of fluid inlet and outlet ports K. The plurality of fluid inlet and outlet ports K are configured to be connected to an externally provided cooling system, so as to realize the circulation of coolant in the liquid cooling plate 200, thereby achieving the purpose of dissipating heat from the battery body 100.

Each of the plurality of connecting tubes 300 corresponds to a respective one of the plurality of fluid inlet and outlet ports K. Each connecting tube 300 may include: a connecting tube body 301, a connecting elbow 302, and a first connecting flange 303. For example, the plurality of fluid inlet and outlet ports K include two fluid inlet and outlet ports, and the plurality of connecting tubes 300 include two connecting tubes. The two fluid inlet and outlet ports K and the two connecting tubes 300 are arranged correspondingly.

In each connecting tube 300, a first end of the connecting tube body 301 is fixedly connected to the liquid cooling plate 200 at a corresponding one of the fluid inlet and outlet ports K, and a second end of the connecting tube body 301 is connected to one end of the connecting elbow 302. The end of the connecting elbow 302 facing away from the connecting tube body 301 is directly fixed to the first connecting flange 303.

In the present disclosure, the side of the first connecting flange 303 facing away from the connecting elbow 302 is configured to connect to an external liquid cooling system, and the liquid cooling plate 200 in the battery module 000 may be connected to the externally provided cooling system via the plurality of connecting tubes 300.

For example, the plurality of fluid inlet and outlet ports K may include: a fluid inlet K1 and a fluid outlet K2. The interior of the liquid cooling plate 200 may have liquid cooling channels connected to the fluid inlet K1 and fluid outlet K2, respectively, and the liquid cooling channels are uniformly distributed inside the liquid cooling plate 200. The connecting tube 300 connected to the fluid inlet K1 may be referred to as a liquid inflow tube, and the connecting tube 300 connected to the fluid outlet K2 may be referred to as a liquid outflow tube. The liquid inflow tube and the liquid outflow tube are respectively connected to the external liquid cooling system, and the coolant of the external liquid cooling system may inject into the liquid cooling channels in the liquid cooling plate 200 via the liquid inflow tube and the fluid inlet K1. Since the liquid cooling channels are uniformly distributed inside the liquid cooling plate 200, the liquid cooling plate 200 can dissipate heat from the battery body 100 on the liquid cooling plate 200.

Generally, since the vertical distance between the first connecting flange 303 and the liquid cooling plate 200 is constant, it is necessary to reduce the width of the portion of the connecting tube 300 distributed on the side of the first connecting flange 303 facing away from the liquid cooling plate 200. However, in current practice, a vertical short tube is usually provided on the side of the first connecting flange facing away from the liquid cooling plate, and the vertical short tube is connected to the end of the connecting tube by a quick connector. However, the height of the quick connector is generally large, thereby resulting in an increased distance between the connecting tube and the liquid cooling plate, and resulting in an increase of the volume of the battery package.

In the embodiments of the present disclosure, by directly fixing the end of the connecting elbow 302 facing away from the connecting tube body 301 to the first connecting flange 303, the vertical short tube provided on the first connecting flange 303 is omitted, and the use of the quick connector is eliminated. This can significantly reduce the space occupied by the entire connecting tube 300 in the direction perpendicular to the liquid cooling plate 200, and can reduce the distance between the connecting tube 300 and the liquid cooling plate 200, and thereby effectively reducing the volume of the battery package.

In summary, the present disclosure provides a battery module, including: a battery body, a liquid cooling plate, and a plurality of connecting tubes. Since the end of the connecting elbow facing away from the connecting tube body is directly fixed to the first connecting flange, it is possible to omit the vertical short tube provided on the first connecting flange and eliminate the need for a quick connector. This can significantly reduce the space occupied by the entire connecting tube in the direction perpendicular to the liquid cooling plate, and can reduce the distance between the connecting tube and the liquid cooling plate, and thereby effectively reducing the volume of the battery package.

In the embodiments of the present disclosure, referring to FIG. 3, which is a schematic structural diagram of a connecting elbow and a first connecting flange provided in an embodiment of the present disclosure. The connecting elbow 302 in the connecting tube 300 may include: an elbow body 3021 and an annular boss 3022. One end of the elbow body 3021 is fixedly connected to the annular boss 3022, and the annular boss 3022 is fixedly connected to the first connecting flange 303.

In this case, the fixed connection between the annular boss 3022 and the first connecting flange 303 improves the structural strength and sealing performance of the connecting tube 300.

For example, the annular boss 3022 in the connecting elbow 302 is welded to the first connecting flange 303. Thus, the welded connection can improve the sealing performance and the mechanical strength between the connecting elbow 302 and the first connecting flange 303.

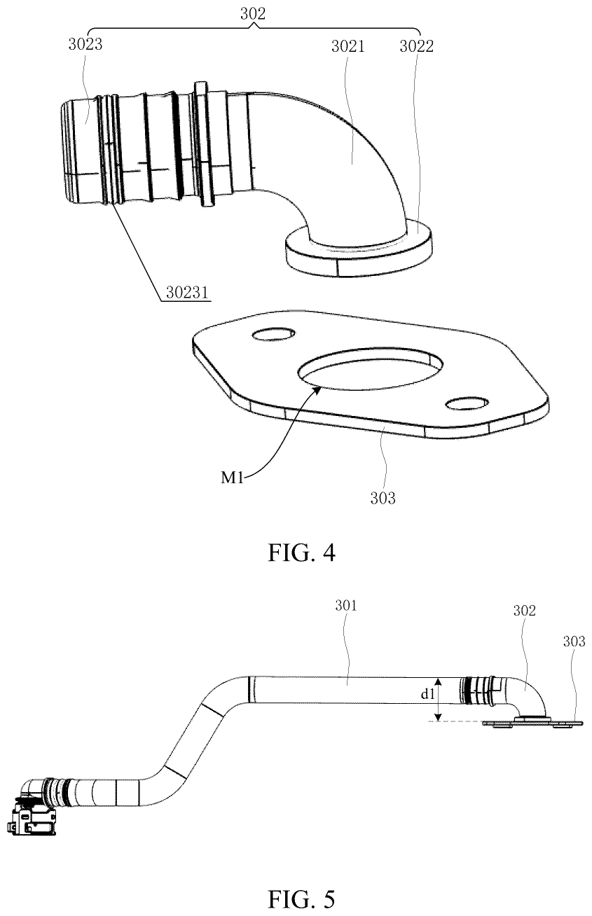

In the embodiments of the present disclosure, referring to FIG. 4, which is an exploded view of the connecting elbow and the first connecting flange as shown in FIG. 3. The first connecting flange 303 in the connecting tube 300 may have a first opening M1, and the first opening M1 is located within the region enclosed by the annular boss 3022 (or the annular boss 3022 is located on the first opening M1).

In this case, the design of the first opening M1 ensures that the coolant can smoothly flow into the connecting elbow 302, thereby improving the heat dissipation efficiency of the liquid cooling plate 200.

In the embodiment of the present disclosure, as shown in FIG. 4, the connecting elbow 302 in the battery module 000 may further include: a snap-fit tube 3023. The snap-fit tube 3023 is detachably connected to the end of the elbow body 3021 facing away from the annular boss 3022.

Since the connecting elbow 302 and the first connecting flange 303 are welded together, the connecting elbow 302 and the first connecting flange 303 thus form an integral unit. During assembly, the connecting tube body 301 may first be assembled onto the liquid cooling plate 200, then the first connecting flange 303 may be assembled to the external liquid cooling system, and finally, the snap-fit tube 3023 is used to assemble the connecting tube body 301 with the assembly of the connecting elbow 302 and the first connecting flange 303. This not only facilitates the assembly between the connecting tube body 301 and the connecting elbow 302, but also facilitates subsequent maintenance and replacement.

Furthermore, in the current art, when assembling the connecting tube with the vertical short tube provided on the first connecting flange, the assembly direction is usually in the direction perpendicular to the liquid cooling plate. However, in the embodiments of the present disclosure, it is unnecessary to provide a vertical short tube on the first connecting flange 303, whereas a connecting elbow 302 is provided on the first connecting flange 303, so the connecting tube body 301 and the snap-fit tube 3023 of the connecting elbow 302 may be assembled in the direction parallel to the liquid cooling plate 200. Thus, by changing the assembly direction from the vertical direction to the horizontal direction, the distance between the connecting tube 300 and the liquid cooling plate 200 can be reduced.

In the embodiment of the present disclosure, as shown in FIG. 4, a plurality of annular snap-fit portions 30231 are provided on the outer wall of the snap-fit tube 3023 in the connecting elbow 302.

After the snap-fit tube 3023 in the connecting elbow 302 is extended into the second end of the connecting tube body 301, the plurality of snap-fit portions 30231 abut against the inner wall of the connecting tube body 301.

In this case, the abutment of the plurality of snap-fit portions 30231 with the inner wall of the connecting tube body 301 enables a stable connection between the connecting elbow 302 and the connecting tube body 301, thereby improving the reliability of the connection. In addition, the design of the snap-fit portions 30231 also helps to enhance the sealing between the connecting elbow 302 and the connecting tube body 301, thereby reducing the risk of leakage.

In the embodiments of the present disclosure, referring to FIG. 5, which is a schematic structural diagram of a connecting tube provided in an embodiment of the present disclosure. In the thickness direction of the liquid cooling plate 200, the maximum distance d1 between the connecting tube body 301 and the first connecting flange 303 in the connecting tube 300 ranges from 20 millimeters (mm) to 40 millimeters.

For example, in the direction perpendicular to the liquid cooling plate 200, the maximum distance d1 between the connecting tube body 301 and the first connecting flange 303 in the connecting tube 300 is 28 mm.

Thus, it can be ensured that the size of the connecting tube 300 in the direction perpendicular to the liquid cooling plate 200 is relatively small, thereby reducing the volume of the battery package and improving space utilization.

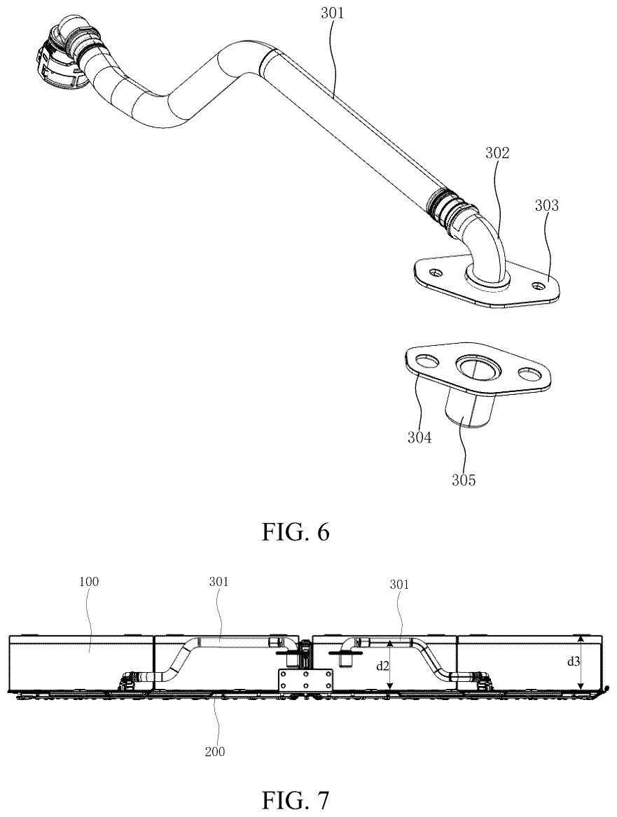

For example, referring to FIG. 6, which is a schematic structural diagram of a connecting tube, a second connecting flange, and a cooling tube provided in an embodiment of the present disclosure. Each connecting tube 300 in the battery module 000 may further include: a second connecting flange 304 and a cooling tube 305.

The second connecting flange 304 in the connecting tube 300 is connected with the first connecting flange 303, and the cooling tube 305 in the connecting tube 300 is connected to the side of the second connecting flange 304 facing away from the first connecting flange 303.

The cooling tube 305 in the connecting tube 300 communicates with the connecting elbow 302 via the second connecting flange 304 and the first connecting flange 303, and the cooling tube 305 is configured to communicate with the liquid cooling system.

In this case, it can be ensured that the external liquid cooling system can communicate with the liquid cooling plate 200 through the connecting tube 300, so that the external liquid cooling system can inject coolant into the interior of the liquid cooling plate 200 through the connecting tube 300, thereby effectively cooling the battery body 100.

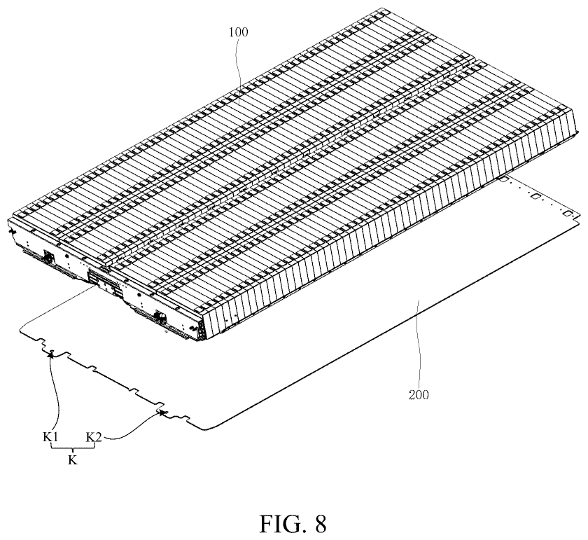

In the embodiments of the present disclosure, referring to FIGS. 7 and 8. FIG. 7 is another schematic structural diagram of a battery module provided in an embodiment of the present disclosure, and FIG. 8 is a partial exploded view of FIG. 1. The plurality of fluid inlet and outlet ports K in the liquid cooling plate 200 are all distributed on the side of the liquid cooling plate 200 supporting the battery body 100.

In the direction perpendicular to the liquid cooling plate 200, the maximum distance d2 between the connecting tube body 301 in the connecting tube 300 and the liquid cooling plate 200 is less than the maximum distance d3 between the side of the battery body 100 facing away from the liquid cooling plate 200 and the liquid cooling plate 200.

In this case, by reducing the maximum distance d2 between the connecting tube body 301 and the liquid cooling plate 200, the entire connecting tube 300 does not extend beyond the side of the battery body 100 facing away from the liquid cooling plate 200, which is conducive to reducing the volume of the battery package and improving space utilization.

In summary, the present disclosure provides a battery module, including: a battery body, a liquid cooling plate, and a plurality of connecting tubes. Since the end of the connecting elbow facing away from the connecting tube body is directly fixed to the first connecting flange, it is possible to omit the vertical short tube provided on the first connecting flange and eliminate the use of quick connectors. This can significantly reduce the space occupied by the entire connecting tube in the direction perpendicular to the liquid cooling plate, and can reduce the distance between the connecting tube and the liquid cooling plate, and thereby effectively reducing the volume of the battery package.

The embodiment of the present disclosure further provides a vehicle, which may be a hybrid vehicle, a pure fuel vehicle, or an extended-range electric vehicle, etc. The vehicle may include: a vehicle body, and a battery module 000 and a liquid cooling system installed in the vehicle body. The liquid cooling plate 200 in the battery module 000 is connected to the liquid cooling system via the connecting tube 300, and the battery module 000 is any one of the aforementioned battery modules 000.

What is claimed is:

1. A battery module, comprising: a battery body, a liquid cooling plate, and a plurality of connecting tubes;
wherein the battery body and the liquid cooling plate are arranged in a stacked manner, and the liquid cooling plate comprises a plurality of fluid inlet and outlet ports;
each of the plurality of connecting tubes corresponds to a respective one of the plurality of fluid inlet and outlet ports, and each of the plurality of connecting tubes comprises: a connecting tube body, a connecting elbow, and a first connecting flange;
wherein, in each of the plurality of connecting tubes, a first end of the connecting tube body is fixedly connected to the liquid cooling plate at a corresponding one of the plurality of fluid inlet and outlet ports, a second end of the connecting tube body is connected to one end of the connecting elbow, and an end of the connecting elbow facing away from the connecting tube body is directly fixed to the first connecting flange.

2. The battery module according to claim 1, wherein the connecting elbow comprises: an elbow body and an annular boss; one end of the elbow body is fixedly connected to the annular boss, and the annular boss is fixedly connected to the first connecting flange.

3. The battery module according to claim 2, wherein the annular boss is connected to the first connecting flange by welding.

4. The battery module according to claim 2, wherein the first connecting flange comprises a first opening, and the annular boss is located on the first opening.

5. The battery module according to claim 2, wherein the connecting elbow further comprises: a snap-fit tube, and the snap-fit tube is detachably connected to an end of the elbow body facing away from the annular boss.

6. The battery module according to claim 5, wherein a plurality of annular snap-fit portions are provided on an outer wall of the snap-fit tube;
wherein, after the snap-fit tube is extended into the second end of the connecting tube body, the plurality of snap-fit portions abut against an inner wall of the connecting tube body.

7. The battery module according to claim 1, wherein, in a thickness direction of the liquid cooling plate, a maximum distance between the connecting tube body and the first connecting flange ranges from 20 millimeters to 40 millimeters.

8. The battery module according to claim 2, wherein, in a thickness direction of the liquid cooling plate, a maximum distance between the connecting tube body and the first connecting flange ranges from 20 millimeters to 40 millimeters.

9. The battery module according to claim 4, wherein, in a thickness direction of the liquid cooling plate, a maximum distance between the connecting tube body and the first connecting flange ranges from 20 millimeters to 40 millimeters.

10. The battery module according to claim 5, wherein, in a thickness direction of the liquid cooling plate, a maximum distance between the connecting tube body and the first connecting flange ranges from 20 millimeters to 40 millimeters.

11. The battery module according to claim 1, wherein each of the connecting tubes further comprises: a second connecting flange and a cooling tube;
the second connecting flange is connected to the first connecting flange, the cooling tube is connected to a side of the second connecting flange facing away from the first connecting flange;
wherein the cooling tube communicates with the connecting elbow via the second connecting flange and the first connecting flange, and the cooling tube is configured to communicate with a liquid cooling system.

12. The battery module according to claim 2, wherein each of the connecting tubes further comprises: a second connecting flange and a cooling tube;
the second connecting flange is connected to the first connecting flange, the cooling tube is connected to a side of the second connecting flange facing away from the first connecting flange;
wherein the cooling tube communicates with the connecting elbow via the second connecting flange and the first connecting flange, and the cooling tube is configured to communicate with a liquid cooling system.

13. The battery module according to claim 3, wherein each of the connecting tubes further comprises: a second connecting flange and a cooling tube;
the second connecting flange is connected to the first connecting flange, the cooling tube is connected to a side of the second connecting flange facing away from the first connecting flange;
wherein the cooling tube communicates with the connecting elbow via the second connecting flange and the first connecting flange, and the cooling tube is configured to communicate with a liquid cooling system.

14. The battery module according to claim 4, wherein each of the connecting tubes further comprises: a second connecting flange and a cooling tube;
the second connecting flange is connected to the first connecting flange, the cooling tube is connected to a side of the second connecting flange facing away from the first connecting flange;
wherein the cooling tube communicates with the connecting elbow via the second connecting flange and the first connecting flange, and the cooling tube is configured to communicate with a liquid cooling system.

15. The battery module according to claim 5, wherein each of the connecting tubes further comprises: a second connecting flange and a cooling tube;
the second connecting flange is connected to the first connecting flange, the cooling tube is connected to a side of the second connecting flange facing away from the first connecting flange;
wherein the cooling tube communicates with the connecting elbow via the second connecting flange and the first connecting flange, and the cooling tube is configured to communicate with a liquid cooling system.

16. The battery module according to claim 1, wherein the plurality of fluid inlet and outlet ports are distributed on a side of the liquid cooling plate supporting the battery body;
in a direction perpendicular to the liquid cooling plate, a maximum distance between the connecting tube body and the liquid cooling plate is less than a maximum distance between a side of the battery body facing away from the liquid cooling plate and the liquid cooling plate.

17. The battery module according to claim 2, wherein the plurality of fluid inlet and outlet ports are distributed on the side of the liquid cooling plate supporting the battery body;
in a direction perpendicular to the liquid cooling plate, a maximum distance between the connecting tube body and the liquid cooling plate is less than a maximum distance between a side of the battery body facing away from the liquid cooling plate and the liquid cooling plate.

18. The battery module according to claim 3, wherein the plurality of fluid inlet and outlet ports are distributed on the side of the liquid cooling plate supporting the battery body;
in a direction perpendicular to the liquid cooling plate, a maximum distance between the connecting tube body and the liquid cooling plate is less than a maximum distance between a side of the battery body facing away from the liquid cooling plate and the liquid cooling plate.

19. The battery module according to claim 4, wherein the plurality of fluid inlet and outlet ports are distributed on the side of the liquid cooling plate supporting the battery body;
in a direction perpendicular to the liquid cooling plate, a maximum distance between the connecting tube body and the liquid cooling plate is less than a maximum distance between a side of the battery body facing away from the liquid cooling plate and the liquid cooling plate.

20. A vehicle, comprising: a vehicle body, and a battery module according to claim 1, and a liquid cooling system installed in the vehicle body, wherein the liquid cooling plate in the battery module is connected to the liquid cooling system via the plurality of connecting tubes.
